(19) United States
(12) Patent Application Publication
(10) Pub. No.: US 2025/0211455 A1
(43) Pub. Date: Jun. 26, 2025

(54) METHOD AND SYSTEM FOR CERTIFICATION OF HOME ELECTRIFICATION ON A BLOCKCHAIN

(71) Applicant: LG ELECTRONICS INC., Seoul (KR)

(72) Inventors: David OLSEN, Seoul (KR); Ajay IYER, Seoul (KR); Jason RYU, Seoul (KR)

(73) Assignee: LG ELECTRONICS INC., Seoul (KR)

(21) Appl. No.: 18/990,431

(22) Filed: Dec. 20, 2024

Related U.S. Application Data
(60) Provisional application No. 63/613,690, filed on Dec. 21, 2023.

(51) Int. Cl. H04L 9/00; G06Q 50/06; G16Y 10/80; G16Y 20/30

(52) U.S. Cl. CPC H04L 9/50; G06Q 50/06; G16Y 10/80; G16Y 20/30

(57) ABSTRACT

A method for providing a decentralized blockchain database comprising energy information for homes includes receiving an application for energy certification of a home, wherein the application includes information on an owner of the home and at least one energy device installed at the home, generating a smart contract associated with the home, wherein the smart contract is configured to track data on energy usage by the at least one energy device installed at the home, and generating an NFT based on the smart contract associated with the home to be maintained on the decentralized blockchain database, wherein metadata of the NFT comprises information on energy efficiency of the home including the at least one energy device.

### CROSS-REFERENCE TO RELATED APPLICATION

Pursuant to 35 U.S.C. § 119(e), this application claims the benefit of U.S. Provisional Patent Application No(s). 63/613,690, filed on Dec. 21, 2023, the contents of which are hereby incorporated by reference herein in its entirety.

### FIELD

The present disclosure generally relates to certification of home electrification and energy usage data using blockchain technology.

### BACKGROUND

Advancements in technology have led to significant improvements in home energy use and efficiency. New technology driven high efficiency appliances, including dryers, washing machines, refrigerators, water heaters, lighting systems, or the like, have contributed to improving energy efficiency in home use. Additionally, alternative energy systems such as solar panel systems and high-capacity energy storage batteries have made it more desirable for a home owner, or prospective home owner, to be able to accurately measure, track, plan, or report energy usage and efficiency of the home.

To this end, an increasing number of home systems and appliances implement networking and communication capabilities, contributing to the Internet-of-Things (IoT), which enables devices with sensors, processing ability, software, and other technologies that connect and exchange data with other devices and systems over the Internet or other communication networks. Home energy systems and devices are therefore increasingly capable of transmitting data on its energy usage, history, efficiency, or the like for storage, billing, reporting, or other uses.

However, currently there exist no solutions for collecting, compiling, certifying, and reporting verified data on energy use and efficiency of a home, either to the home owner, or other individuals or entities who are granted access to such data, such as prospective home purchasers or renters, electrification system vendors, government agencies, energy utility companies, or the like. As an example, with the rising cost of energy, prospective purchasers or renters of a home are increasingly likely to consider energy usage and efficiency when shopping and comparing homes for purchase or rent.

Meanwhile, home appliances and devices are manufactured by an increasingly varying number of different companies and manufacturers, in turn leading to a correspondingly increasing number of proprietary communication implementations and disparate data collection databases. As such, it is difficult to collect and compile energy usage data from all of the various appliances or energy systems installed and used in a particular home. While an energy utility company servicing the home may provide a single source for data on total energy usage, there have been no solutions offered which correlates total energy usage data with verified and installed specific appliances, devices, or energy systems at the home.

Currently, no solution connects internet-of-things (IoT) appliances enabled in the home for the purposes of evaluating, tracking, and providing the rigor required for certifying the level of electrification of a home. The development of such a solution may encourage homeowners to electrify their homes and install more energy efficient appliances and systems. Such a solution would also help the homeowner identify cost-effective upgrades to reduce energy bills, take advantage of rebates from governmental agencies and programs, and obtain certification to improve the market value of the home. Additionally, there are no solutions which provide the security and verification of a public distributed ledger on a peer-to-peer network to avoid requiring any trusted authority or central server for all home data.

Thus, the existing approaches lack a solution for gathering, certifying, and presenting energy data on home energy usage and efficiency.

### SUMMARY

Accordingly, an object of the present disclosure is to address the above challenges by providing a method and system for certification of home electrification on a blockchain.

Embodiments of the present disclosure include systems, apparatuses, and methods for registering, certifying, maintaining, and providing data on energy usage and efficiency of a home based on its installed devices and energy systems. The solutions provided herein provide an extensible and scalable platform using a two pronged approach: the embodiments may interface with IoT-enabled appliances including smart meters in the home as well as external energy agencies such as utility providers or distributed energy resource platforms to source required energy information; and the embodiments may provide a comprehensive overview and traceability of the energy generation and consumption data in the home for certification, auditing, analysis, and review purposes.

An implementation of the present disclosure includes a method for providing a decentralized blockchain database comprising energy information for homes, including receiving an application for energy certification of a home, wherein the application includes information on an owner of the home and at least one energy device installed at the home; generating a smart contract associated with the home, wherein the smart contract is configured to track data on energy usage by the at least one energy device installed at the home; and generating an NFT based on the smart contract associated with the home to be maintained on the decentralized blockchain database, wherein metadata of the NFT comprises information on energy efficiency of the home including the at least one energy device.

In some implementations, the method further includes providing the smart contract associated with the home to a certifying authority for approval prior to generating the NFT.

In some implementations, the method further includes further comprising receiving energy usage data of one or more energy devices installed at the home from an external database; and causing the smart contract to trigger an update procedure for the generated NFT based on the received energy usage data.

In some implementations, the smart contract is configured to generate a hash value corresponding to the received energy usage data and comparing it to a previously stored hash value associated with the home to determine whether the update procedure is to be triggered.

In some implementations, the update procedure includes providing the received energy usage data to a certifying authority for audit of the energy usage data based on triggering the smart contract.

In some implementations, based on receiving approval of the audit from the certifying authority for the energy usage data, the method further includes removing the generated NFT from the decentralized blockchain database and generating an updated NFT associated with the home based on the energy usage data.

In some implementations, the method may further include receiving a request to update the generated NFT based on installation of a new energy device at the home; and causing the smart contract to trigger an update procedure for the generated NFT based on the received request.

In some implementations, the NFT is provided to a digital wallet associated with the owner of the home.

In some implementations, different portions of the metadata of the NFT are accessible to a viewer of the NFT based on an authentication level of the viewer.

Another implementation of the present disclosure includes a method for providing a certification database comprising energy information for homes, including receiving an application for energy certification of a home, wherein the application includes information on an owner of the home and at least one energy device installed at the home, tracking data on energy usage by the at least one energy device installed at the home, and generating a home certification based on the tracked data to be maintained at the certification database, wherein metadata of the home certification comprises information on energy efficiency of the home including the at least one energy device.

According to an implementation, the method may further include receiving energy usage data of one or more energy devices installed at the home from an external database; and triggering an update procedure for the generated home certification based on the received energy usage data.

According to an implementation, the method may further include generating a hash value corresponding to the received energy usage data and comparing it to a previously stored hash value associated with the home to determine whether the update procedure is to be triggered.

Another implementation of the present disclosure includes a non-transitory computer-readable medium storing instructions that, when executed by one or more processors of an electronic device, cause causes the electronic device to receive an application for energy certification of a home to be provided on a decentralized blockchain database, wherein the application includes information on an owner of the home and at least one energy device installed at the home; generate a smart contract associated with the home, wherein the smart contract is configured to track data on energy usage by the at least one energy device installed at the home; and generate an NFT based on the smart contract associated with the home to be maintained on the decentralized blockchain database, wherein metadata of the NFT comprises information on energy efficiency of the home including the at least one energy device.

Yet another implementation of the present disclosure includes an electronic device for providing a decentralized blockchain database comprising energy information for homes, the device comprising: one or more processors; a transceiver; a memory storing instructions that, when executed by the one or more processors, cause causes the device to perform operations comprising: receiving, via the transceiver, an application for energy certification of a home, wherein the application includes information on an owner of the home and at least one energy device installed at the home; generating a smart contract associated with the home, wherein the smart contract is configured to track data on energy usage by the at least one energy device installed at the home; providing the smart contract associated with the home to a certifying authority for approval; and generating an NFT based on the smart contract associated with the home to be maintained on the decentralized blockchain database based on receiving approval from the certifying authority, wherein metadata of the NFT comprises information on energy efficiency of the home including the at least one energy device.

In accordance with some implementations, a computing or electronic device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of an electronic device, cause the electronic device to perform or cause performance of any of the methods described herein. In accordance with some implementations, an electronic device includes: one or more processors, a non-transitory memory, and means for performing or causing performance of any of the methods described herein.

The present disclosure is not limited to what has been described above, and other aspects and advantages of the present disclosure not mentioned above will be understood through the following description of implementations of the present disclosure. Further, it will be understood that the aspects and advantages of the present disclosure may be achieved by the configurations described in claims and combinations thereof.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example a computer in accordance with an embodiment of the present disclosure.

FIG. 2 is a block diagram of an example of a device in accordance with an embodiment of the present disclosure.

FIG. 3 depicts examples of stakeholders and users according to an embodiment of the present disclosure.

FIG. 4 depicts a diagram showing an example of a first issuance of a home certification according to an embodiment of the present disclosure.

FIGS. 5A and 5B depict features related to an example of an update process of a home certification NFT according to embodiments of the present disclosure.

FIG. 6 shows an example of a first issuance of a home certification NFT requested by a home builder according to an embodiment of the present disclosure.

FIG. 7 shows an example of a process performed for installation and configuration of a new appliance at the home according to an embodiment of the present disclosure.

FIG. 8 shows examples of roles of the homeowner according to embodiments of the present disclosure.

FIG. 9 is a diagram depicting an overview of various components and stakeholders according to embodiments of the present disclosure.

FIG. 10 is an example of a method according to an embodiment of the present disclosure.

FIG. 11 is an example of a method of triggering an update according to an embodiment of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

Hereinafter, the implementations disclosed in the present specification will be described in detail with reference to the accompanying drawings, the same or similar elements regardless of a reference numeral are denoted by the same reference numeral, and a duplicate description thereof will be omitted. In the following description, the terms “module” and “unit” for referring to elements are assigned and used interchangeably in consideration of convenience of explanation, and thus, the terms per se do not necessarily have different meanings or functions. Wherever possible, the same reference numbers will be used throughout the drawings to refer to the same or like parts. In the following description, known functions or structures, which may confuse the substance of the present disclosure, are not explained. The accompanying drawings are used to help easily explain various technical features, and it should be understood that the implementations presented herein are not limited by the accompanying drawings. As such, the present disclosure should be construed to extend to any alterations, equivalents, and substitutes in addition to those which are particularly set out in the accompanying drawings.

The terminology used herein is used for the purpose of describing particular example implementations only and is not intended to be limiting. As used herein, the singular forms “a,” “an,” and “the” may be intended to include the plural forms as well, unless the context clearly indicates otherwise. The terms “comprises,” “comprising,” “includes,” “including,” “containing,” “has,” “having” or other variations thereof are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

Hereinafter, implementations of the present disclosure will be described in detail with reference to the accompanying drawings. Like reference numerals designate like elements throughout the specification, and overlapping descriptions of the elements will not be provided.

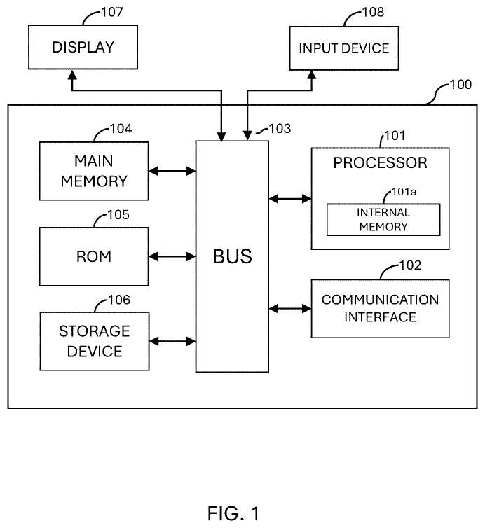

Referring now to FIG. 1, an illustration of an example computer 100 is provided which may be used to embody, implement, execute, or perform embodiments of the present disclosure. In selected embodiments, the computer 100 may include a bus 103 (or multiple buses) or other communication mechanism, a processor 101, processor internal memory 101a, main memory 104, read only memory (ROM) 1305, one or more additional storage devices 106, and/or a communication interface 102, or the like or sub-combinations thereof. The embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. In all embodiments, the various components described herein may be implemented as a single component, or alternatively may be implemented in various separate components.

A bus 103 or other communication mechanism, including multiple such buses or mechanisms, may support communication of information within the computer 100. The processor 101 may be connected to the bus 103 and process information. In selected embodiments, the processor 101 may be a specialized or dedicated microprocessor configured to perform particular tasks in accordance with the features and aspects disclosed herein by executing machine-readable software code defining the particular tasks. In some embodiments, multiple processors 101 may be provided with each processing unit dedicated to a particular specialized task, such as graphics processing or artificial intelligence related processing.

Main memory 104 (e.g., random access memory—or RAM—or other dynamic storage device) may be connected to the bus 103 and store information and instructions to be executed by the processor 101. Processor 101 may also include internal memory 101a, such as CPU cache implemented by SRAM, for storing data used for executing instructions. Utilization of internal memory 101a may optimize data and memory management by reducing memory bandwidth usage with main memory 104. Although FIG. 1 depicts internal memory 101a as a component of processor 101, it will be understood that embodiments are included wherein internal memory 101a is a separate component apart from processor 101. Main memory 104 may also store temporary variables or other intermediate information during execution of such instructions.

ROM 105 or some other static storage device may be connected to a bus 103 and store static information and instructions for the processor 101. An additional storage device 106 (e.g., a magnetic disk, optical disk, memory card, or the like) may be connected to the bus 103. The main memory 104, ROM 105, and the additional storage device 106 may include a non-transitory computer-readable medium holding information, instructions, or some combination thereof, for example instructions that when executed by the processor 101, cause the computer 100 to perform one or more operations of a method as described herein. A communication interface 102 may also be connected to the bus 103. A communication interface 102 may provide or support two-way data communication between a computer 100 and one or more external devices (e.g., other devices contained within the computing environment).

In selected embodiments, the computer 100 may be connected (e.g., via a bus) to a display 107. The display 107 may use any suitable mechanism to communicate information to a user of a computer 100. For example, the display 107 may include or utilize a liquid crystal display (LCD), light emitting diode (LED) display, projector, or other display device to present information to a user of the computer 100 in a visual display. One or more input devices 108 (e.g., an alphanumeric keyboard, mouse, microphone, stylus pen) may be connected to the bus 103 to communicate information and commands to the computer 100. In selected embodiments, one input device 108 may provide or support control over the positioning of a cursor to allow for selection and execution of various objects, files, programs, and the like provided by the computer 1300 and displayed by the display 107.

The computer 100 may be used to transmit, receive, decode, display, or the like one or more image or video files. In selected embodiments, such transmitting, receiving, decoding, and displaying may be in response to the processor 101 executing one or more sequences of one or more instructions contained in main memory 104. Such instructions may be read into main memory 104 from another non-transitory computer-readable medium (e.g., a storage device).

Execution of sequences of instructions contained in main memory 104 may cause the processor 101 to perform one or more of the procedures or steps described herein. In selected embodiments, one or more processors in a multi-processing arrangement may also be employed to execute sequences of instructions contained in main memory 104. Alternatively, or in addition thereto, firmware may be used in place of, or in connection with, software instructions to implement procedures or steps in accordance with the features and aspects disclosed herein. Thus, embodiments in accordance with the features and aspects disclosed herein may not be limited to any specific combination of hardware circuitry and software.

Non-transitory computer readable medium may refer to any medium that participates in holding instructions for execution by the processor 101, or that stores data for processing by a computer, and comprise all computer-readable media, with the sole exception being a transitory, propagating signal. Such a non-transitory computer readable medium may include, but is not limited to, non-volatile media, volatile media, and temporary storage media (e.g., cache memory). Non-volatile media may include optical or magnetic disks, such as an additional storage device. Volatile media may include dynamic memory, such as main memory. Common forms of non-transitory computer-readable media may include, for example, a hard disk, a floppy disk, magnetic tape, or any other magnetic medium, a CD-ROM, DVD, Blu-ray or other optical medium, RAM, PROM, EPROM, FLASH-EPROM, any other memory card, chip, or cartridge, or any other memory medium from which a computer can read.

In selected embodiments, a communication interface 102 may provide or support external, two-way data communication to or via a network link. For example, a communication interface 102 may be a wireless network interface controller or a cellular radio providing a data communication network connection. Alternatively, a communication interface 102 may comprise a local area network (LAN) card providing a data communication connection to a compatible LAN. In any such embodiment, a communication interface 102 may send and receive electrical, electromagnetic, or optical signals conveying information.

A network link may provide data communication through one or more networks to other data devices (e.g., other computers such as 100, or terminals of various other types). For example, a network link may provide a connection through a local network of a host computer or to data equipment operated by an Internet Service Provider (ISP). An ISP may, in turn, provide data communication services through the Internet. Accordingly, a computer 100 may send and receive commands, data, or combinations thereof, including program code, through one or more networks, a network link, and communication interface 102. Thus, the computer 100 may interface or otherwise communicate with a remote server, or some combination thereof.

The various devices, modules, terminals, and the like discussed herein may be implemented on a computer by execution of software comprising machine instructions read from computer-readable medium, as discussed above. In certain embodiments, several hardware aspects may be implemented using a single computer, in other embodiments multiple computers, input/output systems and hardware may be used to implement the system.

For a software implementation, certain embodiments described herein may be implemented with separate software modules, such as procedures and functions, each of which perform one or more of the functions and operations described herein. The software codes can be implemented with a software application written in any suitable programming language and may be stored in memory and executed by a controller or processor.

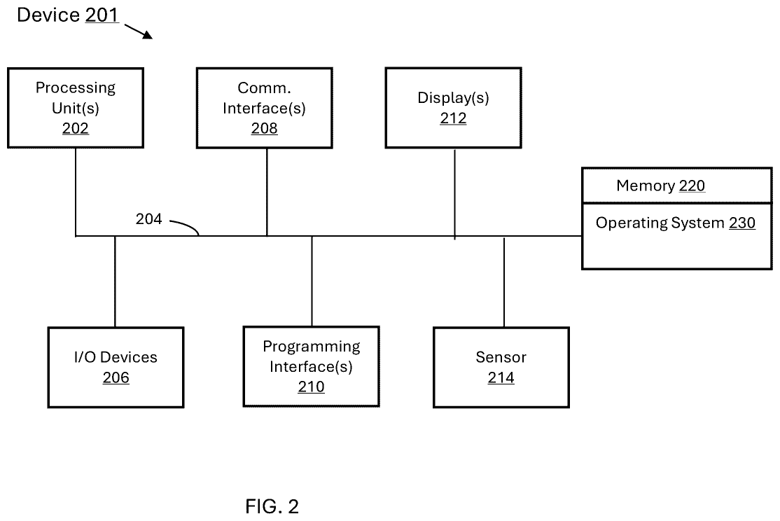

FIG. 2 is a block diagram of an example of a device 201, also referred to as an edge device, deployed device, target computing platform, or the like, in accordance with some implementations. While certain specific features are illustrated, those of ordinary skill in the art will appreciate from the present disclosure that various other features have not been illustrated for the sake of brevity, and so as not to obscure more pertinent aspects of the implementations disclosed herein.

To that end, as a non-limiting example, in some implementations the edge device (in some cases implemented as the computer 100 shown in FIG. 1) or the device 201 includes one or more processing units 202 (e.g., microprocessors, ASICs, FPGAs, GPUs, CPUs, processing cores, and/or the like), one or more I/O devices and sensors 206, one or more communications interfaces 208 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like, type interfaces), one or more programming (e.g., I/O) interfaces 210, one or more displays 212, one or more exterior image sensors 214, a memory 220, and one or more communication buses 204 for interconnecting these and various other components.

In some implementations, the one or more communication buses 204 include circuitry that interconnects and controls communications between system components.

In some implementations, the one or more displays 212 are capable of presenting content. In some implementations, the one or more displays 212 are also configured to present flat video content to the user (e.g., a 2-dimensional or “flat” audio video interleave (AVI), flash video (FLV), Windows Media Video (WMV), or the like file associated with a TV episode or a movie, or live video pass-through of the operating environments.

In some implementations, the one or more displays 212 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro mechanical systems (MEMS), and/or the like display types. In some implementations, the one or more displays 212 correspond to diffractive, reflective, polarized, holographic, etc. waveguide displays. For example, the device 201 includes a single display. In another example, the device 201 includes a display for each eye of the user.

In some implementations, the one or more exterior image sensors 214 are configured to obtain image data frames. For example, the one or more optional exterior-and/or interior-facing image sensors 214 correspond to one or more RGB cameras (e.g., with a complementary metal-oxide-semiconductor (CMOS) image sensor, or a charge-coupled device (CCD) image sensor), infrared (IR) image sensors, event-based cameras, and/or the like.

The memory 220 includes high-speed random-access memory, such as DRAM, SRAM, DDR RAM, or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230. The optional operating system 230 includes procedures for handling various basic system services and for performing hardware dependent tasks.

FIG. 2 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

The following discussion is provided merely by way of summary and background with respect to blockchain and distributed ledger technologies. However, it will be known by those of ordinary skill in the art that variations on the basic concepts presented are considered with respect to the main features of the present disclosure. As known by those of ordinary skill in the art, a distributed ledger is a database that is consensually shared and synchronized across multiple sites, institutions, or geographies, accessible by multiple entities. It allows transactions to have public “witnesses.” The participant at each node of the network can access the recordings shared across that network and can own an identical copy of it.

Any changes or additions made to the ledger are reflected and copied to all participants in a matter of seconds or minutes. A distributed ledger stands in contrast to a centralized ledger, which is a traditional type of ledger maintained by a centralized entity. Among other disadvantages, a centralized ledger may be more prone to cyber-attacks and fraud, as it has a single point of failure. Additionally, the need for a central authority to keep a check against manipulation is eliminated by the use of a distributed ledger.

Distributed ledgers may be permissioned or permissionless. This determines if anyone or only approved people can run a node to validate transactions. They also vary between the consensus algorithm-proof of work, proof of stake, voting systems and hash graph. They may be mineable (one can claim ownership of new coins contributing with a node) or not (the creator of the cryptocurrency owns all at the beginning).

A blockchain is a growing list of records, called blocks, that are linked together using cryptography. In some examples, each block contains a cryptographic hash of the previous block, a timestamp, and transaction data (generally represented as a Merkle tree). The timestamp proves that the transaction data existed when the block was published in order to get into its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks.

Blockchains are typically managed by a peer-to-peer network for use as a publicly distributed ledger, where nodes collectively adhere to a protocol to communicate and validate new blocks. Blockchains may be considered secure by design and exemplify a distributed computing system with high Byzantine fault tolerance. To assure the integrity of a block and the data contained in it, the block is usually digitally signed.

The use of a blockchain removes the characteristic of infinite reproducibility from a digital asset, such as a non-fungible token (NFT). It confirms that each unit of value was transferred only once, solving the long-standing problem of double spending. A blockchain has been described as a value-exchange protocol. A blockchain can maintain title rights because, when properly set up to detail the exchange agreement, it provides a record that compels offer and acceptance.

Logically, a blockchain can be seen as consisting of several layers: infrastructure (e.g., hardware); networking (e.g., node discovery, information propagation and verification); consensus (e.g., proof of work, proof of stake); data (e.g., blocks, transactions); and application (e.g., smart contracts/decentralized applications, if applicable).

By storing data across its peer-to-peer network, the blockchain eliminates a number of risks that come with data being held centrally. The decentralized blockchain may use ad hoc message passing and distributed networking. Peer-to-peer blockchain networks lack centralized points of vulnerability that computer crackers can exploit; likewise, it has no central point of failure.

Blockchain security methods include the use of public-key cryptography. A public key (a long, random-looking string of numbers) is an address on the blockchain. Value tokens sent across the network are recorded as belonging to that address. A private key is like a password that gives its owner access to their digital assets or the means to otherwise interact with the various capabilities that blockchains now support. Data stored on the blockchain is generally considered incorruptible.

Transactions are broadcast to the network using software. Messages are delivered on a best-effort basis. Mining nodes validate transactions, add them to the block they are building, and then broadcast the completed block to other nodes. Blockchains use various time-stamping schemes, such as proof-of-work, to serialize changes. Alternative consensus methods include proof-of-stake. Growth of a decentralized blockchain is accompanied by the risk of centralization because the computer resources required to process larger amounts of data become more expensive.

An advantage to an open, permissionless, or public, blockchain network is that guarding against bad actors is not required and no access control is needed. This means that applications can be added to the network without the approval or trust of others, using the blockchain as a transport layer.

“Smart contracts” is a term used to describe computer code that automatically executes all or parts of an agreement and is stored on a blockchain-based platform. Each smart contract consists of code specifying predetermined conditions that, when met, trigger outcomes. The code itself is replicated across multiple nodes of a blockchain and, therefore, benefits from the security, permanence and immutability that a blockchain offers. By running on a decentralized blockchain instead of a centralized server, smart contracts allow multiple parties to come to a shared result in an accurate, timely, and tamper-proof manner. One smart contract can have multiple different conditions and one application can have multiple different smart contracts to support an interconnected set of processes.

Embodiments of a method and system for certification of home electrification on a blockchain according to the present disclosure will now be discussed.

Embodiments of the present disclosure may provide a technological platform for automatic certification of home electrification. There may be multiple authorized stakeholders in such a system, including homeowners, professional home installers and/or contractors, and certification and regulatory authorities. The embodiments of the present disclosure may capture home-related information such as a list of installed appliances, their energy efficiency, and whole energy usage on a secure, private platform. IoT-enabled devices may initiate and perform automatic energy audits, review results, and perform automatic home certification.

According to some embodiments, utility providers and/or distributed energy resource (DER) platforms (e.g., LEAP.energy) may be enabled to connect to the platforms disclosed. Embodiments may also include features for automatic logging and audit of responses to demand response (DR) events (e.g., EV charging) and other energy-intensive actions during DR events.

In some embodiments, component features of the platform, such as front-end, backend, database, microservices, and APIs, may be built and implemented using distributed-ledger and Web3 technologies, such as blockchain, decentralized applications (DApps), smart contracts, and decentralized autonomous organizations (DAOs).

Embodiments of the present disclosure will now be discussed with respect to implementation using a distributed ledger maintained on a blockchain. However, it will be understood by those of the ordinary skill in the art that other implementations are also considered by this disclosure, including centralized database storage of all energy usage and home certification data.

Some advantages of a blockchain based certifiable home and device registration platform are presented. Blockchain technology may power a decentralized registration and tracking platform. The blockchain based platform may enable different appliance manufacturers to maintain proprietary data ownership, consumer privacy, and still cooperate with other brands in a whole home ecosystem.

Embodiments of the present disclosure may enable transparent and traceable ownership of renewable energy assets, for example including solar panels, battery systems, and the like; home assets, for example including EV chargers, HVAC appliances, and the like; customer owned assets, for example including washers, dryers, energy efficient appliances, and the like; and purchased and generated environmental credits, for example including renewable energy certificates (RECs), and the like.

Embodiments of the present disclosure may enable automatic auditability. This may include self-reporting by appliances of manufacturer details and estimated energy efficiency, measuring and documenting actual energy usage based on smart plugs, devices, and IoT sensors, tracking whole home energy usage based on smart meters, documenting response to DR events, tracking time of use (TOU) pricing-based usage behaviors, and verifying source of purchased and generated environmental credits.

Embodiments of the present disclosure may also enable secure transferability of home ownership to a new buyer upon sale of a home. This may include transfer of ownership of appliances and systems included as part of the home purchase to the new buyer, and de-registration of appliances and systems that are not included in the home sale. Additionally, the transfer may include the transfer of ownership of environmental credits with the home, along with transfer of certification of home electrification generated based on the present disclosure.

Embodiments of the present disclosure may also enable tracking of energy generation, including renewable energy generated by home solar systems, renewable energy transferred to the grid from the home, and renewable energy used from the grid by the home.

Additionally, embodiments of the present disclosure include issuance of an NFT representing certification of home energy usage and efficiency, which will be discussed further below.

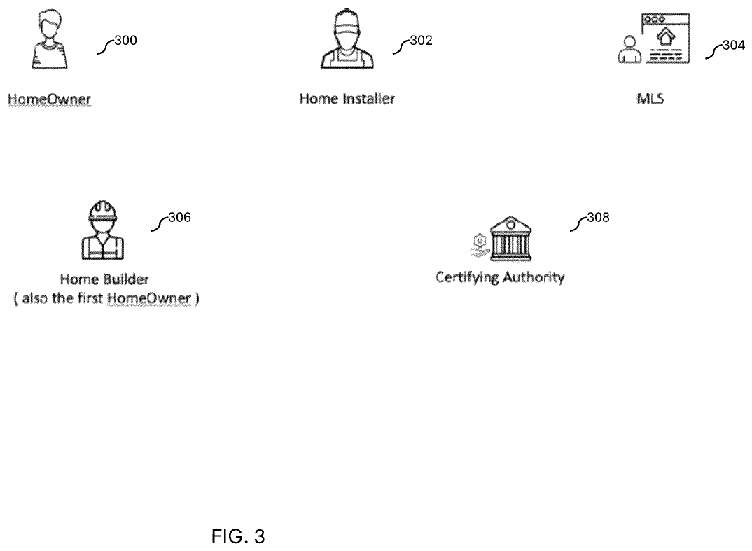

According to embodiments of the present disclosure, a certification and device registration system and process may be provided, for which there may be 5 main stakeholders and users. Referring to FIG. 3, this may include the homeowner 300, home installer 302, a real estate information database service such as an Multiple Listing Service (MLS) 304, a home builder 306—who may assume the role of the first homeowner 300, prior to the first sale of the home, and a certifying authority 308.

MLS 304, otherwise referred to as a listing service 304, may refer to a multiple listing service, such as www.MLS.com, or other database created by collaborating real estate agents containing properties for sale, allowing brokers and agents to see one another's listings of properties for sale or rent. This may also include affiliated databases and websites, including for example, ZILLOW, REDFIN, REALTOR.COM, or the like. In some embodiments, the listing service 304 may receive home certifications from other entities such as the homeowner 300, home installer 302, home builder 306, certifying authority 308, and update a listing associated with the home to make the certification available for viewing or inspection by prospective purchasers or renters.

In some embodiments the certifying authority 308 may be a third-party entity responsible for receiving and auditing home information, including home ownership, address, appliance and systems installation, and data on home energy usage and setup. For example, various established testing and certification laboratories may be entities tasked with the certifying authority 308 role. However, other embodiments are considered in which the certifying authority 308 is undertaken by any entity with the capabilities of fulfilling such role, including governmental organizations or entities, or private organizations or entities.

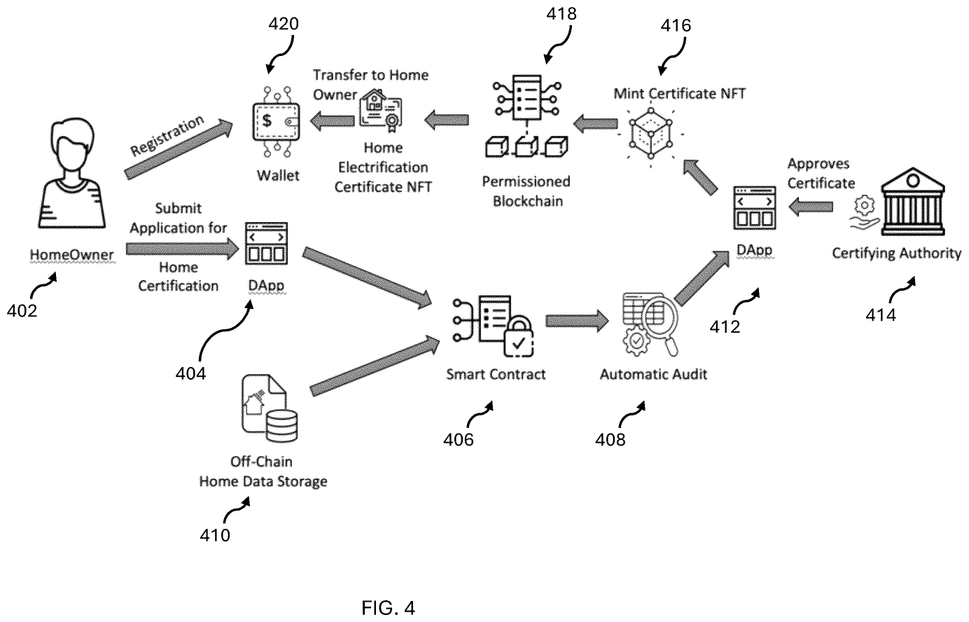

FIG. 4 depicts a diagram showing an example of a first issuance of a home certification NFT according to an embodiment of the present disclosure. In the example, the homeowner 402 is the initiator of the home certification process. The homeowner 402 may apply for certification of the home through a decentralized app, or DApp 404.

The application submitted by the homeowner may include manually entered home and owner information, including the owner's personal information, address, number of residents, age of residents, and the like, which may be considered in evaluating the home energy usage and needs. The application may also include information on energy systems and appliances installed and in-use at the home, as well as IoT device information, including serial or model numbers, and database access information, such as login and password information associated with the IoT systems.

The application for certification through the DApp 404 may trigger the creation of a smart contract 402 to be maintained on the blockchain. The smart contract 406 may be configured to trigger an automatic audit 408 of the electrification of the home associated with the homeowner 402 based on certain conditions being met or certain events triggering the audit. In some examples, the smart contract 406 may trigger the automatic audit 408 based on conditions or events including the submission of the initial application for home certification by home owner 402, the passage of a certain period of time since the previous audit, the installation of a new home appliance or energy system at the home, the listing of a home for sale, usage of a certain amount of electricity at the home, usage of a certain amount of electricity during a particular time period of the day, electric car charging times or amount thresholds, or the like.

In some embodiments, the smart contract 402 may be configured to store the received data from each off-chain home data storage 410. The data may include energy systems or appliance information, or energy usage data, or the like. The data may be encrypted and compressed into a corresponding hash value. The hash value may be stored on the blockchain. In such embodiments, the smart contract 410 may be configured to check the off-chain home data storage 410 at predetermined intervals, e.g., one week, one month, or the like, and generate an updated hash value based on updated received data maintained at the off-chain home data storage 410. If the smart contract 402 determines that the updated hash value is different from the most recently stored hash value maintained on the blockchain, it may trigger an automatic audit 408 of the electrification of the home.

The blockchain and the smart contract 406 may receive data from external data sources, otherwise referred to as off-chain home data storage 410. The off-chain home data storage may include databases storing information on energy usage, appliance or electrification system installation and usage, or other data pertaining to energy usage and efficiency of the home. The off-chain home data storage 410 may be owned, operated, maintained by a third party associated with an energy appliance, device, or system installed and operated at the home.

For example, in some embodiments, the off-chain home data storage 401 may correspond to a database associated with an IoT connected appliance installed at the home, such as a smart thermostat, smart refrigerator, smart water heater, electric car charger, energy meter, heat pump, demand response data, or the like. In the embodiments, the off-chain home data storage 401 is generated and maintained by third parties. The off-chain home data storage 410 may be configured to provide information such as systems or appliance installation, energy usage data, user settings, appliance or system settings information, user history, event history, and the like, collected and/or stored in connection with the appliance, to the smart contract 406 maintained on the blockchain.

It will be understood by those of ordinary skill in the art that although FIG. 4 depicts one off-chain home data storage 410, numerous off-chain home data storage 410 databases may be configured and connected to the blockchain and the smart contact 406 to provide energy usage and related data associated with various appliances, systems, and energy usage related devices at the home. In some embodiments, it is also considered that the data provided by the off-chain data storage 410 may be stored on the blockchain itself.

The smart contract 406 may trigger an automatic audit 408 of the home electrification information by a certifying authority 414. As discussed, the certifying authority 414 may correspond to a third-party entity responsible for receiving and auditing home information, including home ownership, address, appliance and systems installation, and data on home energy usage and setup. As shown in FIG. 4, the certifying authority 414 may receive new or updated information on the home electrification based on the off-chain home data storage (or the initial application submitted by the homeowner 402) and conduct an audit of the information.

The certifying authority 414 may be tasked with generating and maintaining the blockchain for provisioning of the home electrification certificates and corresponding tokens. In the example shown in FIG. 4, the initial application submitted by the homeowner 402 may trigger the automatic audit 408 by the certifying authority 414. In the initial audit, the certifying authority 414 may obtain data entered by the homeowner 414 (or homebuilder in the case of a new home build), and confirm that the data is in compliance with all predefined requirements, and/or consistent with other data points in provided.

The audit may be automated at the certifying authority. The audit may be based on the information generated and stored at the off-chain data storage 410 by systems and appliances installed at the home, for example, the connected IoT devices, smart meters, and the like. In an example of an automatic audit triggered by an application for home certification submitted by the homeowner 402, the audit may include confirmation that the data received from the off-chain data storage 410 is consistent with the information entered by the homeowner 402, for example, appliance model or serial numbers, installation details, warranty or rebate information, or the like.

In another example in which the automatic audit is triggered by the smart contract based on an elapsed time period or energy usage threshold, the automatic audit 408 may include determining whether energy usage at the home is within range of an expected energy usage based on the systems and appliances registered on the blockchain as being installed and in-use at the home.

As one example, where a previous update to the home certification included installation of 15 energy generating solar panels and a battery storage unit at the home, an automatic audit 408 by the certifying authority may include confirmation that energy received by the home from the energy grid, based on data received from a smart metering system, is within an expected and/or reasonable range given the energy generating capabilities of the particular installed solar panels and previous history of energy usage at the home, and also confirmation that energy provided back to the grid using the battery storage unit is within an expected and/or reasonable range given the energy storage capabilities of the battery storage unit and the previous history of energy usage at the home.

The above example is simplified for this disclosure, however it will be understood that data across different systems and appliance ecosystems stored by different off-chain home data storage 410 may be considered during an automated audit 408 performed at the certifying authority 414. For example, the above example may also include consideration of data received from off-chain home data storage 410 for smart metering systems, electric car chargers, home appliances, home heating and cooling systems, and the like.

Upon approval of the audit by the certifying authority 414, a home certification may be issued, and a non-fungible token (NFT) may be minted on the blockchain 418 associated with the certification and maintained by the certifying authority 414. In some embodiments, a manual final approval must be obtained prior to certification and issuance of the NFT. In other embodiments, the entire audit and certification process may be automated and not require any manual review or final approval.

In some embodiments, the minted NFT may be an upgradable NFT, which is capable of being updated and changed based on additional information, including updates to the home certification. In other embodiments, the minted NFT may be a static NFT which cannot be updated or changed, and any update to the home certification may require delisting the static NFT and minting a new NFT based on updated information on the home certification.

Ownership of the NFT may be transferred to the homeowner 402, where the NFT is stored in the homeowner's eWallet 420. The homeowner 402 may have the capability of sharing the NFT for viewing with others from the eWallet 402.

The NFT may include information on the electrification of the home, including appliances and systems registered as being installed at the home, as well as energy usage information associated with the home. The NFT may be configured for by different stakeholders with each having different levels of access. For example, the homeowner 402 may have the highest level of access, with the ability to view all the details on appliances and systems installed at the home, including for example, date of installation, date of certification, energy usage history, purchase history, maintenance history, certification expiration, and the like.

In some embodiments, the above data on home electrification may be configured as the metadata associated with the NFT with different credentialed access levels. In some cases, the NFT may include a general score or grade based on the home electrification, total energy usage level, renewable energy generation or usage, cost to the homeowner of operating based on energy usage, or the like, that is viewable by all or most levels of access, with the metadata having different levels of access.

In other embodiments, the NFT itself may be a complication of the data that is viewable by different levels of credentials on the blockchain as defined by the certifying authority.

Other levels of credentials for access to the NFT data may include, for example as discussed above with respect to FIG. 3, the home builder 306, home installer 302, and MLS 308. For new home builds, the home builder 306 may take the role of the first homeowner prior to the first sale of the home. Once the home is purchased by the homeowner 300, the homeowner 300 may be given full access to all data associated with the NFT, and the home builder 306 access may be downgraded to a level equivalent to a non-credentialed public viewer of the NFT, such as read-only access.

The home installer 302 may include contractors or installers, or the like, tasked with installation of energy related systems or appliances at the home. For example, the home installer 302 may correspond to a solar panel installation company, a home appliance installer, an electric car charger installer, or the like. The home installer 302 may have access to update the NFT with new information associated with the energy system or appliance upon completion of the installation. The home installer 302 may have access to submit information associated with the system or appliance type, brand, model number, serial number, energy usage specifications, settings, and the like, which may cause the smart contract to trigger an automated audit by the certifying authority, as discussed above. Once the NFT is updated with the data submitted by the home installer 302, the access of the home installer 302 may be downgraded to a level equivalent to a non-credentialed public viewer of the NFT, such as read-only access.

MLS 304 may be a database created by collaborating real estate agents containing properties for sale, allowing brokers and agents to see one another's listings of properties for sale or rent. In some embodiments, MLS may have access to view or make available for viewing through its portals the data of the NFT associated with the home. This may include information such as a general score or grade based on the home electrification, total energy usage level, renewable energy generation or usage, cost to the homeowner of operating based on energy usage, or the like, that is viewable by those with access to the MLS databases. Data available to MLS 304 may be at a lower level than that of homeowner 300 to protect private or confidential information, and MLS 304 may also only have read access to make energy related information available for viewing that may be relevant in a home purchase or leasing decision.

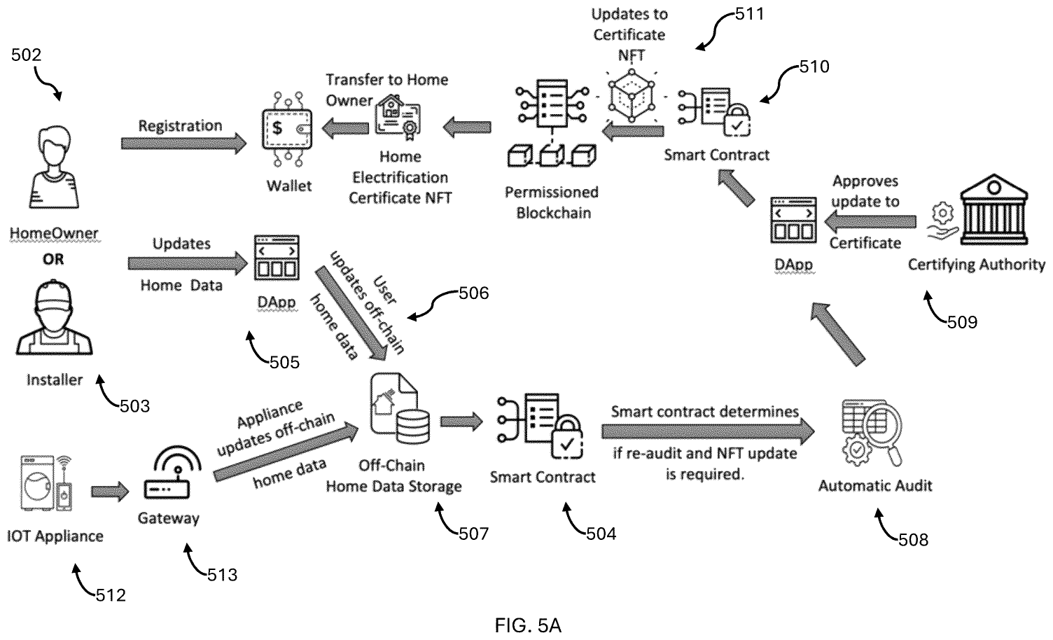

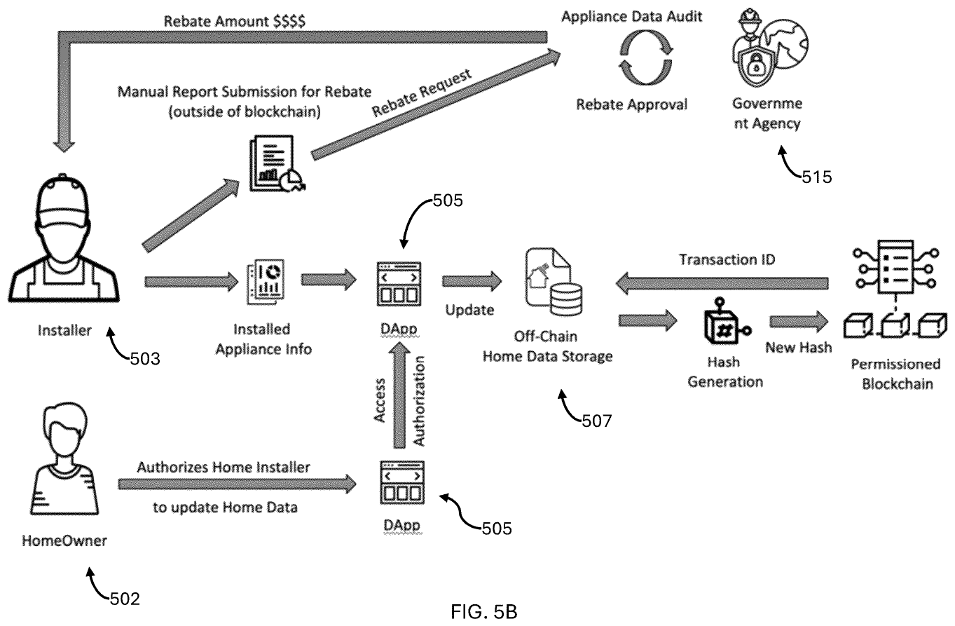

FIG. 5A depicts a diagram showing an example of an update process of a home certification NFT, according to an embodiment of the present disclosure. In one example, the home installer 503 is the initiator of the update process based on installation of a new appliance 512 at the home. In the case of the home installer 503, the installer may be hired by the homeowner 502 to install a new system or appliance at the home, such as an electric vehicle charging station.

In another example, the homeowner 502 is the initiator of the update process based on an update 506 to the off-chain home data via the DApp 505. For example, the homeowner 502 may change device history or usage information, decommission a system or appliance, or install a new system or appliance themselves in a DIY installation, or submit the update information after completion of the installation performed by the home installer. In one example, the homeowner may purchase and install a smart thermostat which controls the home's existing HVAC system.

However, it will be understood that update of the home certification and NFT may be triggered by various stakeholders, events, or conditions, as previously discussed.

During the installation of the appliance 512, the appliance may be configured and connected to the off-chain home data storage 507 via a gateway 513, such as the internet. Upon completion of the installation, the home installer 503 or homeowner 502 may submit information of newly installed system information via the DApp 505. The submitted update may interface and be authenticated with the data maintained on the off-chain home data storage 507 associated with the installed system. The off-chain home data storage may be monitored by the smart contract 504. Based on the new information on the installed system, the smart contract 504 may trigger an automatic audit 508 of the home energy information, including the newly installed system.

The automatic audit 508 performed at the certifying authority may be similar to the audit discussed above with respect to the initial issuance of the home certification, additionally including audit of the newly submitted information regarding the recently installed system at the home.

Based on approval of the automatic update 508 by the certifying authority 509, a smart contract 510 may be configured for determining whether the previously minted NFT must be updated or not. If the home certification data is substantively changed based on the installation of the system by the home installer or the homeowner-or some other data added since the last automatic audit-the smart contract 510 may be configured to trigger an upgrade 511 to the existing upgradable NFT associated with the home certification. In some embodiments, the determination of upgrading the NFT may be performed by smart contract 504. In some embodiments, smart contract 510 and smart contract 504 correspond to the same smart contract. The update may be determined based on the hash value generated using the updated information submitted by the homeowner 502 or the home installer 503, in comparison to the hash value previously stored on the blockchain, as discussed above.

Based on the upgrade of the NFT, the upgraded NFT reflecting data of the new system installation by the homeowner 502 or the home installer 503 may be reflected in the NFT and home certification.

Additional details regarding the update to the NFT based on installation of a new appliance at the home are shown in FIG. 5B, specifically for submission of appliance information for rebate purposes. Many energy efficient systems and appliances may be connected with rebates offered by government agencies, such as municipalities or energy companies. In such cases, the home installer 503 may be tasked with submitting data associated with the installation for receiving the rebate, separate and apart from the updates to the NFT and blockchain information.

In an embodiment, the home installer 503 may be authorized by the homeowner 502 to update the home data via the DApp 505, and also to generate reports from the DApp 505 for submission to a government agency 515 for receiving any rebates associated with purchase or installation of the new appliance. The government agency may also implement data audits of the appliance data submitted by the installer, for issuance of the rebate back to the homeowner 502 or to the home installer 503.

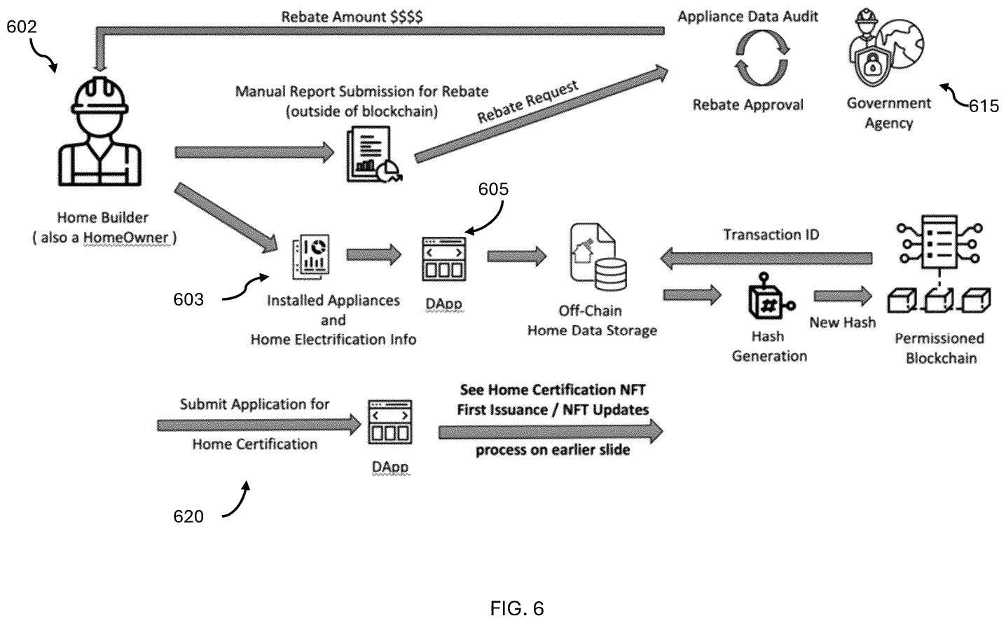

FIG. 6 shows an example of a first issuance of a home certification NFT requested by the home builder 602 according to an embodiment of the present disclosure. Contrasted with the example of FIG. 4 in which a homeowner 502 was the initiator of the certification process-for example, after purchasing the home which did not previously have a certification issued-the example of FIG. 6 shows the home builder 602 as the initiator of the home certification process based a brand new home build.

The home builder 602 may apply for certification of the home through the DApp 605. The application 620 may include information 603 on all of the installed systems and appliances at the home, including all home electrification information. For example, new home builds may include HVAC systems, smart water heaters, water pumps, solar panels, or the like, the information for which is all included in the application submitted by the home builder 602.

Upon submission of the application 620 for electrification certification of the home, the process for interfacing with the various off-chain home data storage databases, and approval of automatic audits by a certifying authority may be similar to the examples discussed above with respect to FIG. 4.

Similar to the example shown in FIG. 5B, the home builder 602 may also submit a report for rebates in connection with any of the installed systems or appliances to a government agency 615.

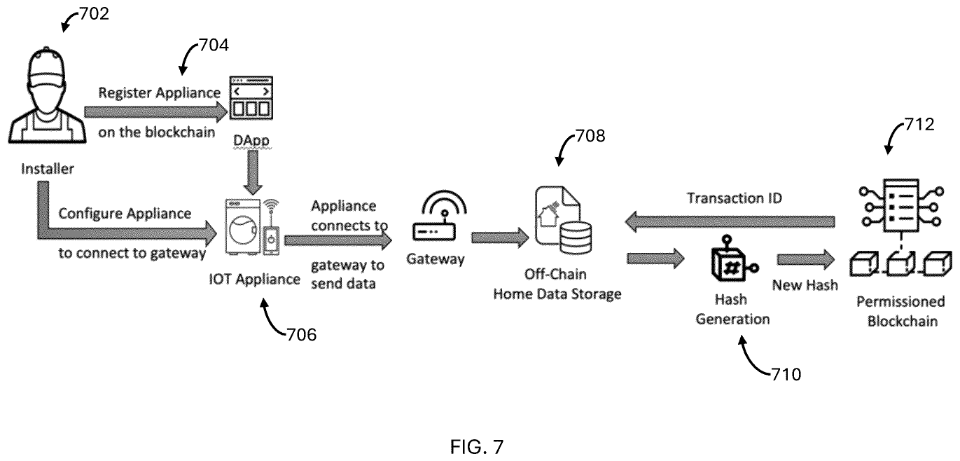

Referring to FIG. 7, an example of a process performed for installation and configuration of a new appliance at the home is shown. In an embodiment, an installer 702 of a new appliance 706 at the home, such as a new HVAC system, refrigerator, washer, dryer, smart water heaters, or the like, may submit an application 704 to register the new appliance on the blockchain. The application may include all information related to the home and the owner, as well as the installed appliance, including brand, model number, warranty information, user configuration settings, scheduling settings, or the like.

The appliance may be installed and configured to connect to a gateway to access a network, such as the Internet, for transmitting and receiving information between an off-chain data storage associated with the installed appliance. The installed appliance may communicate with the off-chain data storage according to a schedule set by the installer or the homeowner to transmit usage and settings information, or the communication may take place in response to certain usage thresholds or triggering events.

A smart contract associated with the registered home may use a previously stored hash for determining whether an update to the maintained blockchain entry for the home is required. Based on the newly submitted application to register the installed appliance, the smart contract may determine that an update is required, and trigger an update of the NFT associated with the home to be stored on the blockchain 712. Based on the updated information including the newly installed appliance, a new hash value 710 may be generated and stored in connection with the home registration for future updates.

In some embodiments, the smart contract may be configured to periodically receive snapshots of the data from the off-chain data storage and trigger the update based on the update schedule, without a determination on the update status of the data.

In some embodiments, the smart contract may be configured to monitor the off-chain data storage to detect variances in energy usage or detect non-compliance with the home certification program. For example, where the smart contract detects that data is not being received from an off-chain data storage associated with a home thermostat that was previously registered as being installed at the home, the smart contract may trigger an automated audit by the certifying authority to ensure compliance with the previous certification details of the home. In some cases, a threshold number of non-compliance events may be configured before an automatic audit is required by the smart contract or by the certifying authority. In some embodiments, a separate smart contract may be configured for compliance monitoring, apart from the smart contract configured for home energy data tracking.

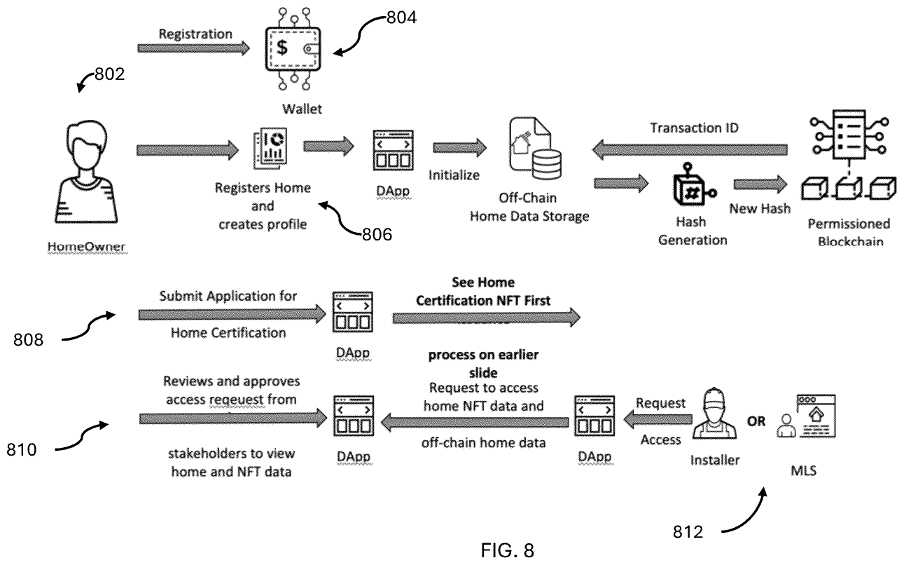

FIG. 8 shows examples of roles of the homeowner according to embodiments of the present disclosure. For example, the homeowner 802 may have authorization to register themselves on the blockchain 804, generating a homeowner profile, and generating a corresponding e Wallet for storage and management of NFTs associated with homes owned by the homeowner 802.

The homeowner 802 may also register and create a profile for the home 806. As discussed, this may include an application initiated through the DApp, which includes all information of the home, such as address and parcel number (which may provide unique identifiers of the home), home dimensions and statistics, historical annual energy usage, appliances installed at the home, carbon footprint information, purchase date, maintenance dates, and the like.

As discussed, the homeowner 802 may initiate 808 an application to be submitted for initial certification of the home on the blockchain or may also initiate an update to the existing home certification, such as for a new installation of an energy system or appliance, as previously discussed.

The homeowner 802 may also have authority to grant access 810 to third-parties 812 for viewing and/or triggering updates to the home certification. For example, the homeowner 802 may grant access to an installer for submitting an application to trigger an update to the home certification based on installation of a new energy system or appliance at the home, for example as discussed above with respect to FIG. 7. As another example, the homeowner 802 may grant access to MLS to view and/or use all metadata associated with the home certification for a home listing, in the event that the home is being sold or made available for lease. The homeowner may also have authority to transfer ownership of the home certification and NFT to a purchaser or manager of the home.

The above are merely non-limiting examples, and one of ordinary skill will recognize that the homeowner 802, as well as other stakeholders of the system according to embodiments of the present disclosure, may be granted various levels of authority to create, edit, view, modify, or otherwise access or grant access to others, for information or data associated with the home certification, NFT, and blockchain system.

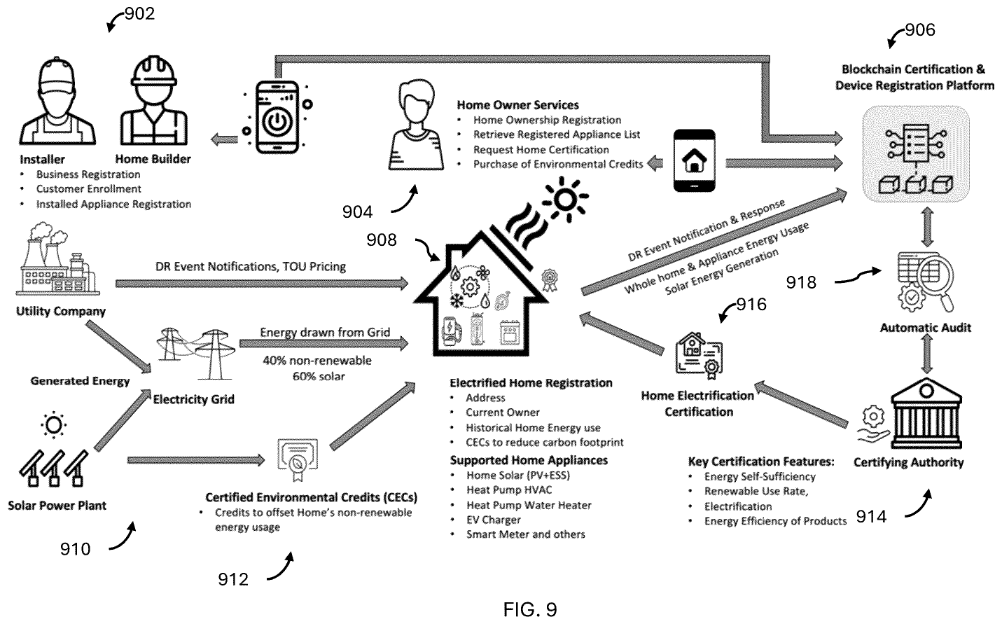

FIG. 9 is a diagram depicting an overview of various components and stakeholders according to an embodiment of the present disclosure. As discussed, embodiments may involve a home certification 916 of electrification and energy usage of a home 908, represented by an NFT. The home certification 916 and NFT may be issued, audited, updated, and/or maintained by a certifying authority 914. In some embodiments the home certification 916 and NFT may be stored on a blockchain 906 for certification and device registration. In other embodiments, the home certification 916 may be stored and maintained on a central storage, such as an off-chain database storage maintained by the certifying authority 914, or another authorized responsible entity.

A home builder 902 of the home 908 may take the role of the first applicant for certification of the home. In other cases, the home owner 904 may take the role of the first applicant for certification, for example in a case where the home owner 904 owns or purchases a home that does not already have an associated home certification. The home owner 904 or home builder 902 may submit an application for registration of the home, including identifying information of the home and the home owner, energy systems and appliances installed at the home, energy settings and historical usage data, and the like. Based on an automatic audit 918 of the data submitted in the application, an NFT may be generated and stored on the blockchain 906. In some embodiments, the automatic audit 918 may result in a home certification 916 being stored and maintained on a central storage, such as an off-chain database storage maintained by the certifying authority 914, or another authorized responsible entity.

A home installer 902 may also be authorized by either the home builder or the home owner 902 to trigger updates to the home registration information. This may take place upon installation of a new energy system or appliance at the home. The installer may submit updated information regarding the newly installed energy system or appliance, including identifying data, brand, model number, date of purchase, date of maintenance, usage and settings information, and the like. The updated information may be transmitted to an off-chain data storage associated with the newly installed energy system or appliance.

Data on electrification of the home may also include information collected or otherwise received from traditional energy source systems, such as the electricity grid 910. This may encompass consolidated energy generated from the utility company or from solar power plants, or other green energy sources. The home electrification data may include the amount of energy drawn from the grid or sourced back to the grid from a home-installed solar energy system, battery backup system, or other green energy generating system. The data may also include demand response event details provided by the utility company in response to high power demand or low supply events, as well as the home electrification system's response to such DR events. Data may also be collected on certified environmental credits (CECs) 912 that offset the home's non-renewable energy usage, for example based on the home's energy generation using solar power generation system.

The above examples of data on home usage and electrification are included merely by way of example and are not to be limiting. It will be understood by those of ordinary skill in the art that numerous other data and information related to home energy systems, appliances, usage, settings, history, or the like, may be received, collected, scraped, inferred, processed, and/or otherwise utilized in achieving the features of the present disclosure.

A smart contract associated with the blockchain may perform periodic checks to determine whether an update to a home certification is required. This may be based on a unique hash value that is generated and stored on the blockchain, identifying all of the above data that was included in a previous update to the home certification. Based on data collected from various off-chain data storage systems associated with energy systems and appliances installed at the home, a new hash value may be generated and compared to the previously stored hash value. Based on the comparison, the smart contract may determine that an update to the home certification is required and trigger an automatic audit 918 of the home data. Based on the automatic audit 918, the home certification 916 and NFT may be updated for storage on the blockchain 906.

Metadata of the NFT may be made available for viewing by third parties by the home builder 902 or the home owner 904. For example, the home owner 904 may grant read only access to MLS for listing the home for sale, in order to make the home electrification certification and data available for viewing by agents and prospective purchasers of the home.

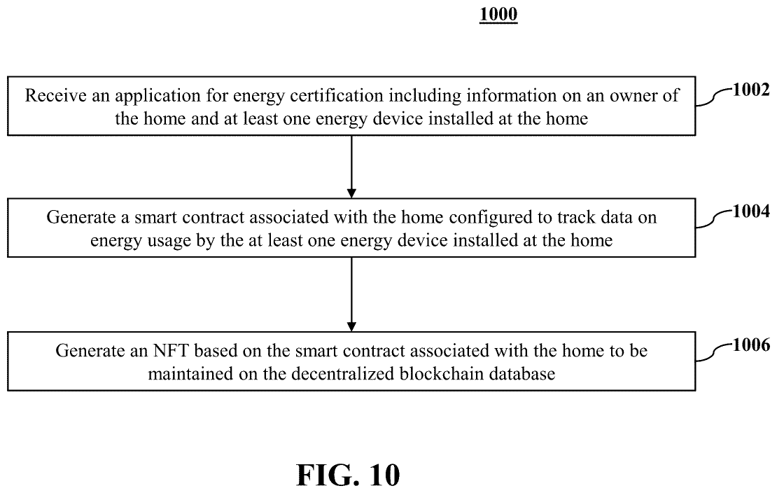

FIG. 10 is an example of a method 1000 according to an embodiment of the present disclosure. The method may include receiving an application for energy certification at 1002.

The application for energy certification may include information on an owner of the home and at least one energy device installed at the home. As discussed, in some embodiments the application may be submitted by the home owner, or a home builder who may assume the role of the initial home owner in the case of a new home build. The application may include identifying information including the home address, parcel number, owner information, as well as home electrification information such as installed home energy systems, appliances, settings, usage history, or the like.

The method 1000 may further include generating a smart contract associated with the home at 1004. As discussed above, the smart contract may be configured to track data on energy usage by the at least one energy device installed at the home. In some embodiments, the smart contract may receive data from external data sources, such as off-chain home data storage. The off-chain home data storage may include databases storing information on energy usage, appliance or electrification system installation and usage, or other data pertaining to energy usage and efficiency of the home. The off-chain home data storage may be owned, operated, maintained by a third party associated with an energy appliance, device, or system installed and operated at the home. In some embodiments, the off-chain home data storage may correspond to a database associated with an IoT connected appliance installed at the home, such as a smart thermostat, smart refrigerator, smart water heater, electric car charger, energy meter, heat pump, demand response data, or the like.

The method 1000 may further include generating an NFT based on the smart contract associated with the home at 1006. As discussed in the above examples, the smart contract may trigger an automatic audit of the home electrification information by a certifying authority. As discussed, the certifying authority may correspond to a third-party entity responsible for receiving and auditing home information, including home ownership, address, appliance and systems installation, and data on home energy usage and setup. As shown in FIG. 4 for example, the certifying authority may receive new or updated information on the home electrification based on the off-chain home data storage (or the initial application submitted by the homeowner) and conduct an audit of the information.

Upon approval of the audit by the certifying authority a home certification may be issued, and a non-fungible token (NFT) may be generated 1006 and minted on the blockchain associated with the certification and maintained by the certifying authority. In some embodiments, a manual final approval must be obtained prior to certification and issuance of the NFT. In other embodiments, the entire audit and certification process may be automated and not require any manual review or final approval.

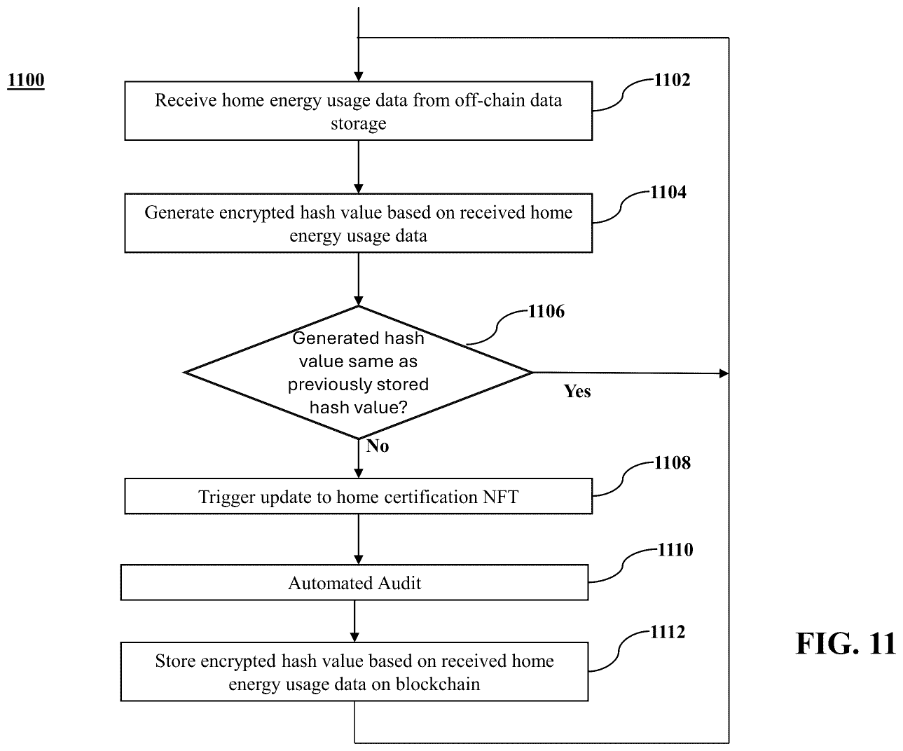

FIG. 11 is an example of a method 1100 of triggering an update to the generated NFT and automatic audit performed by the certifying authority. The method 1100 may include receiving home energy usage data from an off-chain data storage associated with an appliance or energy system installed at the home. Examples of the off-chain data storage are discussed above.

The method 1100 may further include generating an encrypted hash value based on the received home energy usage data at 1104. The data may include energy systems or appliance information, or energy usage data, or the like. The data may be encrypted and compressed into a corresponding hash value. The hash value may be stored on the blockchain. In such embodiments, the smart contract may be configured to check the off-chain home data storage at predetermined intervals, e.g., one week, one month, or the like, and generate an updated hash value based on updated received data maintained at the off-chain home data storage.

The method 1100 may further include comparing the generated hash value with a previously stored hash value stored on the blockchain that is associated with the home energy data, to determine whether the generated hash value is the same as the previously stored hash value, at 1106. If the smart contract determines that the updated hash value is the same as the most recently stored hash value maintained on the blockchain, it may return to performing the method 1100, wherein home energy usage data is received from off-chain data storage at 1102.

Where the smart contract determines that the updated hash value is different from the most recently stored hash value maintained on the blockchain, it may trigger an update to the home certification NFT 1108, resulting in an automatic audit 1110 of the updated home energy usage data. As discussed in the above examples, the smart contract may trigger the automatic audit 1110 of the home electrification information by a certifying authority. The certifying authority may correspond to a third-party entity responsible for receiving and auditing home information, including home ownership, address, appliance and systems installation, and data on home energy usage and setup. As shown in FIG. 4 for example, the certifying authority may receive new or updated information on the home electrification based on the off-chain home data storage and conduct an audit of the information.

The automated audit 1110 may result in the home certification NFT being updated, or a new NFT being minted to be maintained on the blockchain.

The method 1110 may include storing the newly generated hash value based on the received home energy usage data on the blockchain for determining whether to trigger additional updates in the future.

Implementations according to the present disclosure described above may be implemented in the form of computer programs that may be executed through various components on a computer, and such computer programs may be recorded in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present disclosure (especially in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

Operations constituting the method of the present disclosure may be performed in appropriate order unless explicitly described in terms of order or described to the contrary. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the example implementations described above or by the use of such terms unless limited by the appended claims. Therefore, it should be understood that the scope of the present disclosure is not limited to the example implementations described above or by the use of such terms unless limited by the appended claims. Also, it should be apparent to those skilled in the art that various alterations, substitutions, and modifications may be made within the scope of the appended claims or equivalents thereof.

Therefore, technical ideas of the present disclosure are not limited to the above-mentioned implementations, be considered to fall within the scope of the present disclosure.

What is claimed is:

1. A method for providing a decentralized blockchain database comprising energy information for homes, the method comprising:
receiving an application for energy certification of a home, wherein the application includes information on an owner of the home and at least one energy device installed at the home;
generating a smart contract associated with the home, wherein the smart contract is configured to monitor energy related data of the at least one energy device installed at the home; and
generating an NFT based on the smart contract associated with the home to be maintained on the decentralized blockchain database,
wherein metadata of the NFT comprises information on energy efficiency of the home including the at least one energy device.

2. The method of claim 1, further comprising providing the smart contract associated with the home to a certifying authority for approval prior to generating the NFT.

3. The method of claim 1, further comprising receiving the energy related data of one or more energy devices installed at the home from an external database; and
wherein the smart contract triggers an update of the generated NFT based on the received energy related data.

4. The method of claim 3, wherein the smart contract is configured to generate a hash value corresponding to the received energy related data and comparing it to a previously stored hash value associated with the home to determine whether the generated NFT is to be updated.

5. The method of claim 3, wherein updating the generated NFT includes providing the received energy related data to a certifying authority for audit of the energy related data.

6. The method of claim 5, further comprising, based on receiving approval of the audit from the certifying authority for the energy related data, updating the metadata of the NFT associated with the home based on the energy related data.

7. The method of claim 1, further comprising receiving a request to update the generated NFT based on installation of a new energy device at the home; and
wherein the smart contract triggers an update of the generated NFT based on the received request.

8. The method of claim 1, wherein the NFT is provided to a digital wallet associated with the owner of the home.

9. The method of claim 1, wherein different portions of the metadata of the NFT are accessible to a viewer of the NFT based on an authentication level of the viewer.

10. A method for providing a certification database comprising energy information for homes, the method comprising:
receiving an application for energy certification of a home, wherein the application includes information on an owner of the home and at least one energy device installed at the home;
monitoring energy related data of the at least one energy device installed at the home; and
generating a home certification based on the energy related data to be maintained at the certification database,
wherein metadata of the home certification comprises information on energy efficiency of the home including the at least one energy device.

11. The method of claim 10, further comprising receiving the energy related data of one or more energy devices installed at the home from an external database; and
triggering an update procedure for the generated home certification based on the received energy related data.

12. The method of claim 11, further comprising generating a hash value corresponding to the received energy related data and comparing it to a previously stored hash value associated with the home to determine whether the update procedure is to be triggered.

13. A non-transitory computer-readable medium storing instructions that, when executed by one or more processors of an electronic device, cause causes the electronic device to:
receive an application for energy certification of a home to be provided on a decentralized blockchain database, wherein the application includes information on an owner of the home and at least one energy device installed at the home;
generate a smart contract associated with the home, wherein the smart contract is configured to monitor energy related data of the at least one energy device installed at the home; and
generate an NFT based on the smart contract associated with the home to be maintained on the decentralized blockchain database,
wherein metadata of the NFT comprises information on energy efficiency of the home including the at least one energy device.

14. The non-transitory computer-readable medium of claim 13, wherein the instructions further cause the electronic device to provide the smart contract associated with the home to a certifying authority for approval prior to generating the NFT.

15. The non-transitory computer-readable medium of claim 13, wherein the instructions further cause the electronic device to:
receive the energy related data of one or more energy devices installed at the home from an external database,
wherein the smart contract triggers an update of the generated NFT based on the received energy related data.

16. The non-transitory computer-readable medium of claim 15, wherein the smart contract is configured to generate a hash value corresponding to the received energy related data and comparing it to a previously stored hash value associated with the home to determine whether the generated NFT is to be updated.

17. The non-transitory computer-readable medium of claim 15, wherein updating the NFT includes providing the received energy related data to a certifying authority for audit of the energy related data.

18. The non-transitory computer-readable medium of claim 17, wherein the instructions further cause the electronic device to:
based on receiving approval of the audit from the certifying authority for the energy related data, generating an updated NFT associated with the home based on the energy related data.

19. The non-transitory computer-readable medium of claim 13, wherein the instructions further cause the electronic device to:
receive a request to update the generated NFT based on installation of a new energy device at the home,
wherein the smart contract triggers an update of the generated NFT based on the received request.

20. The non-transitory computer-readable medium of claim 13, wherein the NFT is provided to a digital wallet associated with the owner of the home.

21. The non-transitory computer-readable medium of claim 13, wherein different portions of the metadata of the NFT are accessible to a viewer of the NFT based on an authentication level of the viewer.
